(19) United States
(12) Patent Application Publication
(10) Pub. No.: US 2012/0298826 A1
(43) Pub. Date: Nov. 29, 2012

(54) SMARTPHONE HOLDER

(75) Inventor: Yi-Chang Su, Taipei City (TW)

(73) Assignee: EVERCASE TECHNOLOGY INC., Taipei City (TW)

(21) Appl. No.: 13/168,221

(22) Filed: Jun. 24, 2011

(30) Foreign Application Priority Data
May 25, 2011 (CN) 201120176470.5

(51) Int. Cl. H04M 99/00

(52) U.S. Cl. 248/346.03

(57) ABSTRACT

The present invention relates to a smartphone holder for holding a smartphone, comprising a plate body, a first protective strip, a second protective strip, a cylindrical body, and a connector holder. The plate body consists of a back support plate member, a hollowed-out plate member, and a base plate member. The back support plate member, the hollowed-out plate member and the base plate member are formed in one piece or mechanically linked into an S-shape. A cylindrical accommodation space is disposed between the hollowed-out plate member and the base plate member to accommodate the cylindrical body. The first protective strip and the second protective strip are respectively coupled to the left and the right side of the plate body, and each has an annular ring to allow the arrangement of the cylindrical body in the accommodation space inside the plate body. The connector holder is inserted into a hollowed-out socket on the cylindrical body and protrudes out of the hollowed-out plate member of the plate body. The connector holder is for holding the charging connector and/or data transmission connector of a smartphone. The invention provides a device for the placement of a smartphone and makes it convenient for the charging or data transmission of a smartphone.

### FIELD OF THE INVENTION

The present invention relates to a holder, more particularly a holder for a portable smartphone.

### BACKGROUND OF THE INVENTION

FIG. 1 shows a conventional smartphone holder 100. As shown, the smartphone holder 100 has a base body 1, and the top surface of the base body 1 is disposed with a hollowed-out socket 11 and a back support member 12. The back support member 12 is configured at the center area on the top surface of base body 1 and adjacent to the hollowed-out socket 11. The connector 21 of smartphone's connector cable set 2 can be inserted into the hollowed-out socket 11 of base body 1 and protrudes from the base body 1.

To accommodate the different size specifications of smartphones, a conventional smartphone holder 100 is typically installed with an adjustment pad 3 on the back support member 12 of the holder 100 such that when a smartphone with different size specifications (not shown in FIG. 1) is placed on the base body 1, the smartphone's reclining angle may be adjusted using the adjustment pad 3 to facilitate phone operation and viewing by users.

A major drawback of a conventional smartphone holder 100 is that the adjustment pad 3 must be changed when the holder 100 is used to hold a different smartphone in order to adjust the reclining angle of the smartphone on the holder 100. Because the insertion angle and location of the connector 21 on the hollowed-out socket 11 are not adjustable, an overly thick smartphone will not be fitted onto such holder 100 even with the adjustment pad 3 removed. Thus there is a need to develop a holder device that addresses the drawback of prior art.

### SUMMARY OF THE INVENTION

In light of the drawback of prior art, the present invention aims to provide a smartphone holder that can be used for holding a smartphone and enables convenient adjustment of the reclining angle of the smartphone on the holder when it holds smartphones with different size specifications.

Another object of the present invention is to provide a smartphone holder for holding a smartphone upright, thereby making it convenient for users to operate or view the smartphone or use the smartphone for video communication.

To achieve the aforesaid objects, the present invention provides a smartphone holder for holding a smartphone, comprising a plate body, a first protective strip, a second protective strip, a cylindrical body, and a connector holder. The plate body consists of a back support plate member, a hollowed-out plate member, and a base plate member. The back support plate member, the hollowed-out plate member and the base plate member are formed in one piece or mechanically linked into an S-shape. A cylindrical accommodation space is disposed between the hollowed-out plate member and the base plate member to allow the horizontal placement of cylindrical body therein. The cylindrical body possesses a socket body, a first knob member and a second knob member. The first knob member and the second knob member are opposingly disposed on either side of the horizontally positioned socket body. The first knob member, the second knob member and the socket body are mechanically linked or formed in one piece, and are concentrically positioned. The first protective strip and the second protective strip are respectively coupled or glued to the outer edge on the left and the right side of the plate body, and each has an annular ring to allow the respective fitting of the first knob member and the second knob member such that the cylindrical body arranged in the cylindrical accommodation space of the plate body is mechanically configured inside the plate body. The connector holder consists of a holding member and an arc member. It is inserted into a hollowed-out socket on the socket body and protrudes out of the hollowed-out plate member of the plate body. The connector holder is for holding the charging connector and/or data transmission connector of a smartphone in an engaging hole of the holding member. The arc member of the connector holder has a concave hole for the cable of the charging connector and/or data transmission connector to pass through so as to connect an external power supply unit or data transmission unit. The holding member and the arc member are formed in one piece or mechanically linked to form the connector holder.

In comparison with the prior art, the smartphone holder of the invention works by inserting the connector holder into the hollowed-out socket on the rotatable cylindrical body that comes with knobs. As such, users can easily adjust the reclining angle of a smartphone on the smartphone holder through the rotatable cylindrical body, thereby addressing the drawback of unadjustable reclining angle seen in prior art.

The objects, features and effects of the invention are described in detail below with embodiments in reference to the accompanying drawings.

### BRIEF DESCRIPTION OF THE DRAWINGS

FIG. 1 is a schematic view of a conventional smartphone holder;

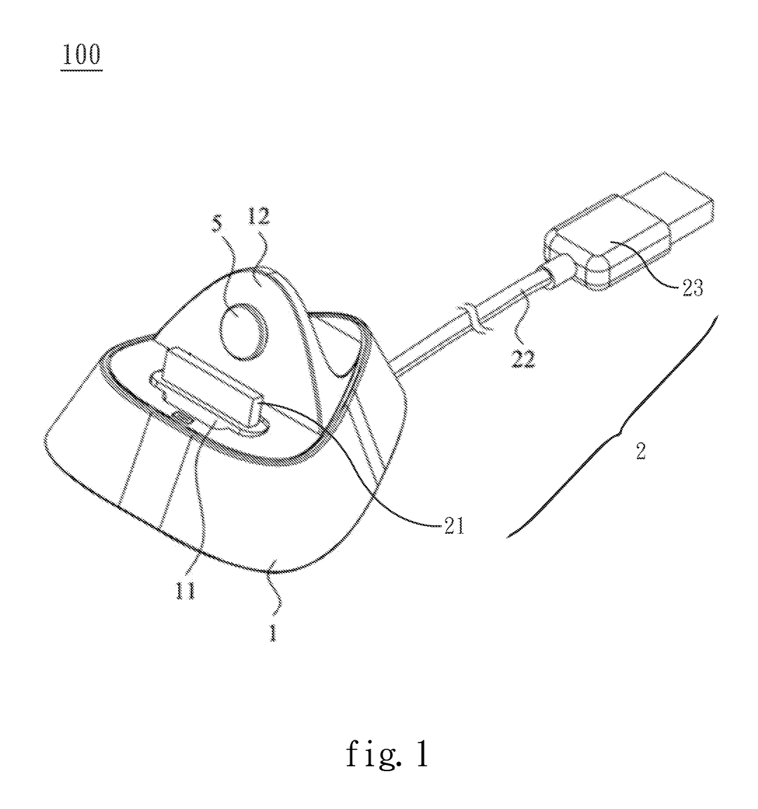

FIG. 2 is an exploded view of a preferred embodiment of the invention;

FIG. 3 is an assembly view of a preferred embodiment of the invention;

FIG. 4 is a side view of a preferred embodiment of the invention; and

FIG. 5 is a schematic view of the connector holder and the cylindrical body in a preferred embodiment of the invention.

### DETAILED DESCRIPTION OF THE INVENTION

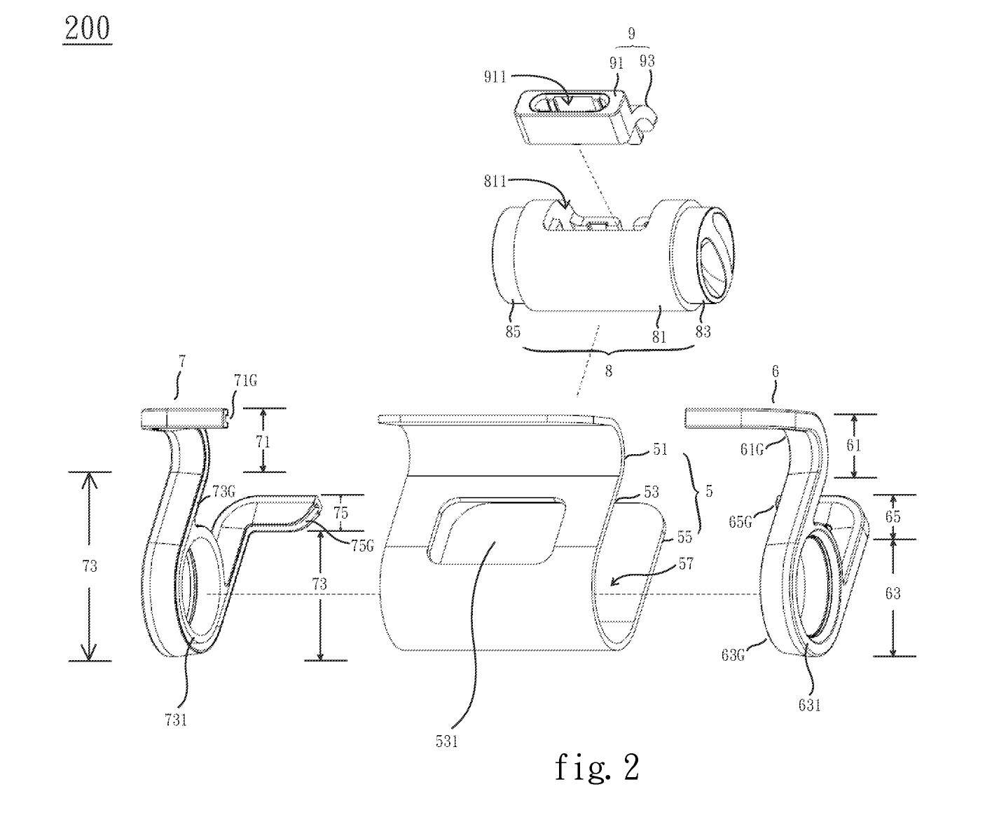

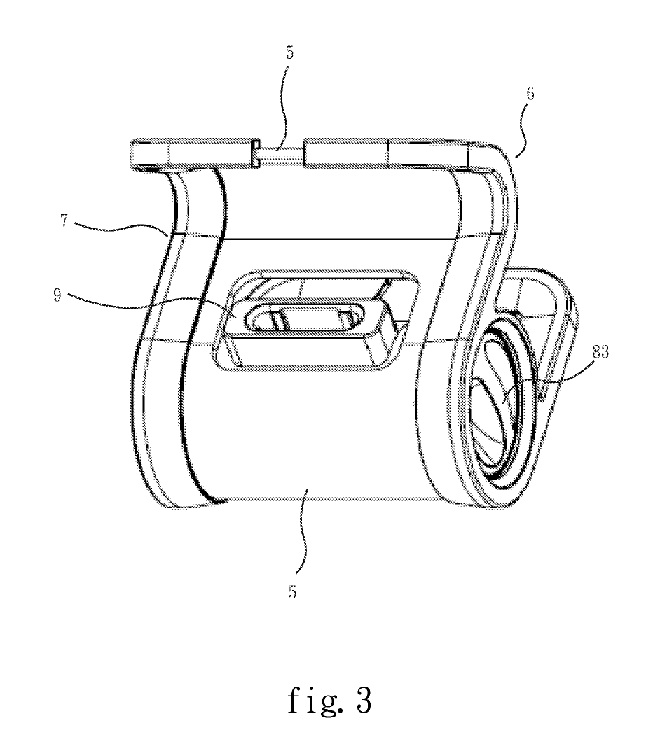

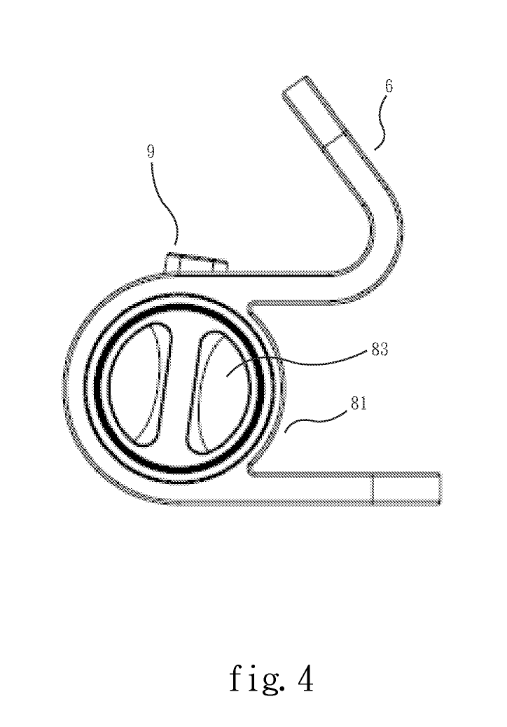

Referring to FIGS. 2-4, FIG. 2 is an exploded view of a preferred embodiment of the invention, FIG. 3 is an assembly view of a preferred embodiment of the invention, and FIG. 4 is a side view of a preferred embodiment of the invention. As shown, a smartphone holder 200 of the invention is sued for holding a smartphone and comprises a plate body 5, a first protective strip 6, a second protective strip 7, a cylindrical body 8 and a connector holder 9. The plate body 5 consists of a back support plate member 51, a hollowed-out plate member 53 and a base plate member 55. The back support plate member 51, hollowed-out plate member 53 and base plate member 55 are formed in one piece or mechanically linked into an S-shape, wherein there is a cylindrical accommodation space 57 disposed between the hollowed-out plate member 53 and the base plate member 55 to allow the horizontal placement of the cylindrical body 8 therebetween. The plate body 5 is made of at least metal, porcelain or plastic.

The cylindrical body 8 consists of a socket body 81, a first knob member 83 and a second knob member 85. The first knob member 83 and the second knob member 85 are opposingly disposed on either side of the horizontally positioned socket body 81. The first knob member 83, the second knob member 85 and the socket body 81 are mechanically linked or formed in one piece, and are concentrically positioned. The socket body 81 has a hollowed-out socket 811. The knob structures of the first knob member 83 and the second knob member 85 are star knob, bar knob, cross knob, knurled knob, or other types of knobs having equivalent effect. In this embodiment, the knob member is a bar knob, and the socket body 81, first knob member 83 and second knob member 85 is made of at least metal, porcelain, rubber or plastic.

As shown in FIG. 3, the first protective strip 6 and the second protective strip 7 are opposingly, symmetrically and mechanically connected to the outer edge of the plate body 5, and the first protective strip 6 and the second protective strip 7 respectively have an annular ring 631 and annular ring 731 to dispose the horizontally placed cylindrical body 8 in the cylindrical accommodation space 57 of the plate body 5. Because the diameters of the first knob member 83 and the second knob member 85 correspond to the diameters of the annular ring 631 and annular ring 731, and those diameters are smaller than the diameter of the socket body 81, the cylindrical body 8 could be securely fitted in the annular ring 631 and annular ring 731 through the first knob member 83 and the second knob member 85 and could easily turn in the annular ring 631 and annular ring 731. That is, the cylindrical body 8 can be turned easily by turning the first knob member 83 or the second knob member 85. In addition, the first protective strip 6 consists of an upper protective strip 61, a middle protective strip 63 and a lower protective strip 65, which are respectively and correspondingly disposed at the outer edge on one side of the back support plate member 51, hollowed-out plate member 53 and base plate member 55 of the plate body 5. It should be noted that the upper protective strip 61, middle protective strip 63 and lower protective strip 65 are formed in one piece or independently formed. In this embodiment, they are formed in one piece. Similarly, the second protective strip 7 consists of an upper protective strip 71, a middle protective strip 73 and a lower protective strip 75, which are respectively and correspondingly disposed at the outer edge on another side of the back support plate member 51, hollowed-out plate member 53 and base plate member 55 of the plate body 5. The upper protective strip 71, middle protective strip 73 and lower protective strip 75 are formed in one piece or independently formed. That is, the first protective strip 6 and the second protective edge 7 can be divided into a plurality of corresponding protective strips, which are respectively and mechanically connected to the plate body 5. In this embodiment, they are formed in one piece. In addition, the first protective strip 6 and the second protective strip 7 similarly have corresponding concave connecting grooves 61G, 63G, 65G and 71G, 73G, 75G to engage the outer edge of the back support plate member 51, hollowed-out plate member 53 and base plate member 55 of the plate body 5 through gluing or screwing. The first protective strip 6 and the second protective strip 7 are made of at least rubber or plastic.

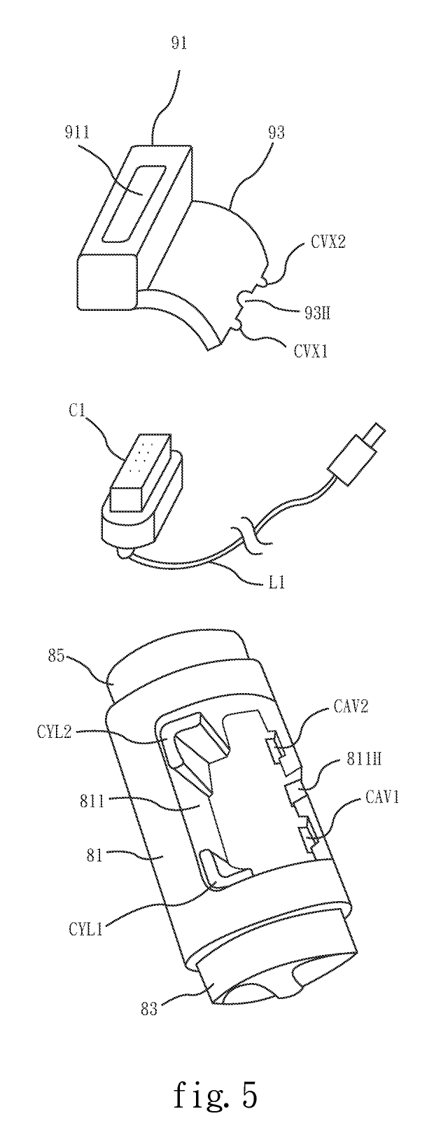

FIG. 5 is a schematic view of the connector holder 9 and the cylindrical body 8 in a preferred embodiment of the invention. As shown, the connector holder 9 has a holding member 91 and an arc member 93. The connector holder 9 is inserted into a hollowed-out socket 811 on the socket body 81 of cylindrical body 8 and protrudes out of the hollowed-out plate member 53 of the plate body 5 (as shown in FIG. 4). The connector holder 9 is for holding a charging connector and/or data transmission connector of a smartphone in an engaging hole 911 of the holding member 91. The arc member 93 of the connector holder 9 has a concave hole 93H for the cable L1 of the charging connector C1 and/or data transmission connector C1 to pass through so as to connect an external power supply unit or data transmission unit. The holding member 91 and the arc member 93 are formed in one piece or mechanically linked to form the connector holder 9. The arc of arc member 93 corresponds to the arc of the cylindrical body 8. In addition, the connector holder 9 is mechanically linked to the hollowed-out socket 811 by engaging its convexities CVX1, CVX2 with the concavities CAV1, CAV2 on the hollowed-out socket 811. The holding member 91 is arranged on the connecting cylinders CYL1 and CYL2 of the hollowed-out socket 811, and the holding member 91 could be further coupled to the connecting cylinders CYL1 and CYL2 using a latch.

The examples given above are not meant to be restrictive. All modifications and alterations without departing from the spirits of the invention shall remain within the protected scope and claims of the invention.

In comparison with the prior art, the smartphone holder of the present invention inserts the connector holder in a hollowed-out socket on a rotatable cylindrical body that comes with knobs. Users can easily adjust the reclining angle of the smartphone in the smartphone holder by turning the cylindrical body, thereby effectively addressing the drawback of unadjustable reclining angle in prior art.

The preferred embodiments of the present invention have been disclosed in the examples. People skilled in the field should understand that examples are given to depict the invention and should not be construed as a limitation on the actual applicable scope of the invention, and as such, all modifications and alterations without departing from the spirits of the invention shall remain within the protected scope and claims of the invention.

What is claimed is:

1. A smartphone holder for holding a smartphone, comprising:
a plate body, comprising:
a back support plate member;
a hollowed-out plate member having a punctured hole; and
a base plate member, and a cylindrical accommodation space being disposed between the hollowed-out plate member and the base plate member;
a first protective strip, having a concave connecting groove for mechanical connection to the outer edge on one side of the plate body, and having an annular ring corresponding to one side of the cylindrical accommodation space;
a second protective strip, having a concave connecting groove for mechanical connection to the outer edge on the other side of the plate body, and having an annular ring corresponding to the other side of the cylindrical accommodation space;
a cylindrical body, comprising:
a socket body, having a hollowed-out socket;
a first knob member; and
a second knob member, wherein the first knob member, the second knob member and the socket body are concentrically positioned, the diameters of the first knob member and the second knob member being corresponding to the diameters of the annular ring of the first protective strip and the second protective strip, and being smaller than the diameter of the socket body such that the cylindrical body could be securely disposed in the annular rings through the first knob member and the second knob member and could easily turn in those annular rings; and
a connector holder, comprising:
a holding member, having an engaging hole to hold the charging connector and/or data transmission connector of a smartphone; and
an arc member, having a concave hole for the cable of the charging connector and/or data transmission connector to pass through so as to connect an external power supply unit or data transmission unit;
wherein the connector holder is inserted into the hollowed-out socket on the socket body of the cylindrical body and protrudes out of the hollowed-out plate member of the plate body through the punctured hole on the hollowed-out plate member.

2. The smartphone holder according to claim 1, wherein the back support plate member, the hollowed-out plate member and the base plate member are formed in one piece or mechanically linked into an S-shape.

3. The smartphone holder according to claim 1, wherein the first protective strip and the second protective strip are respectively formed in one piece.

4. The smartphone holder according to claim 1, wherein the first protective strip and the second protective strip are respectively formed by a plurality of corresponding protective strips respectively and mechanically connected to the plate body.

5. The smartphone holder according to claim 1, wherein the connector holder and the hollowed-out socket engage each other through convexities and concavities.

6. The smartphone holder according to claim 5, wherein the connector holder and the hollowed-out socket are further latched together.

7. The smartphone holder according to claim 1, wherein the plate body is made of at least metal, porcelain or plastic.

8. The smartphone holder according to claim 1, wherein the knob structure of the first knob member and the second knob member is star knob, bar knob, cross knob or knurled knob, and is made of at least metal, porcelain, rubber or plastic.

9. The smartphone holder according to claim 1, wherein the cylindrical body is made of at least metal, porcelain or plastic.
